(19) United States
(12) Patent Application Publication
(10) Pub. No.: US 2025/0225451 A1
(43) Pub. Date: Jul. 10, 2025

(54) OPERATION PLAN FORMULATING DEVICE, VEHICLE DISPATCH MANAGEMENT DEVICE, OPERATION PLAN FORMULATING METHOD, AND STORAGE MEDIUM

(71) Applicant: HONDA MOTOR CO., LTD., Tokyo (JP)

(72) Inventor: Takeru Goto, Wako-shi (JP)

(21) Appl. No.: 18/989,010

(22) Filed: Dec. 20, 2024

(30) Foreign Application Priority Data
Jan. 10, 2024 (JP) 2024-001747

(51) Int. Cl. G06Q 10/0631; G06Q 10/047; G06Q 50/47

(52) U.S. Cl. CPC G06Q 10/06311; G06Q 10/047; G06Q 10/06315; G06Q 50/47

(57) ABSTRACT

An operation plan formulating device includes: an acquisition unit configured to acquire an energy function equation defined as a sum of objective functions relating to an operation plan of the vehicles; and a calculation unit configured to calculate an operation plan minimizing an energy function as an optimal solution, in which the objective functions include one or more first objective functions based on whether or not restriction conditions are satisfied and one or more second objective functions for evaluating a degree of achievement of a target event, the restriction conditions include that a destination of the vehicle is one place, the energy function equation obtains a weighted sum of the first objective functions and the second objective functions, and a weighting assigned to the first objective functions is larger than a weighting assigned to the second objective functions with such a degree.

### CROSS-REFERENCE TO RELATED APPLICATION

Priority is claimed on Japanese Patent Application No. 2024-001747, filed Jan. 10, 2024, the content of which is incorporated herein by reference.

### BACKGROUND OF THE INVENTION

### Field of the Invention

The present invention relates to an operation plan formulating device, a vehicle dispatch management device, an operation plan formulating method, and a storage medium.

### Description of Related Art

Conventionally, an invention of a device that formulates logistics vehicle dispatching as a multi-objective optimization problem and searches for an optimal vehicle dispatching and delivery sequence by applying an annealing method is known (for example, see Patent Document 1 represented below).
[Patent Document 1] Japanese Patent No. 2816802

### SUMMARY OF THE INVENTION

The conventional technology can be applied to a case in which delivery objects and available trucks are defined in advance, and there are cases in which it cannot respond to a situation changing from moment to moment in accordance with vehicle dispatch requests of customers.

An aspect relating to the present invention is in consideration of such situations, and one object thereof is to provide an operation plan formulating device, a vehicle dispatch management device, an operation plan formulating method, and a storage medium capable of responding to a situation changing from moment to moment.

In order to solve the problem described above, the present invention employs the following aspects.

(1): An operation plan formulating device according to one aspect of the present invention is an operation plan formulating device formulating an operation plan of a plurality of vehicles in a service for a vehicle to transport a passenger from a boarding location to a drop-off location, the operation plan formulating device including: an acquisition unit acquiring an energy function equation defined as a sum of objective functions relating to the operation plan of the vehicles; and a calculation unit calculating an operation plan minimizing a value of the energy function equation as an optimal solution, in which the objective functions include one or more first objective functions based on whether or not restriction conditions are satisfied and one or more second objective functions for evaluating a degree of achievement of a target event, the restriction conditions include that a destination of the vehicle is one place, the energy function equation obtains a weighted sum of the one or more first objective functions and the one or more second objective functions, and a weighting assigned to the one or more first objective functions is larger than a weighting assigned to the one or more second objective functions with such a degree that an operation plan for which the restriction conditions are not satisfied is not selected.

(2): In the aspect (1) described above, the operation plan may define which vehicle is heading toward a certain boarding location, and which vehicle is heading toward a certain vehicle depot for a given boarding request.

(3): In the aspect (2) described above, the operation plan may further define an arrangement of one or more vehicle depots.

(4): In the aspect (1) described above, the target event may include a passenger whose waiting time has been long being prioritized and going to pick up many passengers.

(5): In the aspect (1) described above, the target event may include shortening of a total required time until arrival at a boarding location at the time of going to pick up a passenger.

(6): In the aspect (3) described above, the target event may include placing many vehicles at a vehicle depot near a place at which an appearance frequency of passengers is high.

(7): In the aspect (2) described above, the target event may include shortening of a total required time until arrival of a vehicle at a vehicle depot.

(8): According to one aspect of the present invention, there is provided a vehicle dispatch management device including: the operation plan formulating device according to the aspect (1) described above; and a plan instructing unit transmitting the operation plan calculated by the calculation unit to at least a vehicle.

(9) An operation plan formulating method according to one aspect of the present invention is an operation plan formulating method executed using a computer and formulating an operation plan of a plurality of vehicles in a service for a vehicle to transport a passenger from a boarding location to a drop-off location, the operation plan formulating method including: acquiring an energy function equation defined as a sum of objective functions relating to the operation plan of the vehicles; and calculating an operation plan minimizing a value of the energy function equation as an optimal solution, in which the objective functions include one or more first objective functions based on whether or not restriction conditions are satisfied and one or more second objective functions for evaluating a degree of achievement of a target event, the restriction conditions include that a destination of the vehicle is one place, the energy function equation obtains a weighted sum of the one or more first objective functions and the one or more second objective functions, and a weighting assigned to the one or more first objective functions is larger than a weighting assigned to the one or more second objective functions with such a degree that an operation plan for which the restriction conditions are not satisfied is not selected.

(10): A computer-readable non-transitory storage medium according to one aspect of the present invention is a computer-readable non-transitory storage medium storing a program for formulating an operation plan of a plurality of vehicles in a service for a vehicle to transport a passenger from a boarding location to a drop-off location, the computer-readable non-transitory storage medium causing a computer to perform: acquiring an energy function equation defined as a sum of objective functions relating to the operation plan of the vehicles; and calculating an operation plan minimizing a value of the energy function equation as an optimal solution, in which the objective functions include one or more first objective functions based on whether or not restriction conditions are satisfied and one or more second objective functions for evaluating a degree of achievement of a target event, the restriction conditions include that a destination of the vehicle is one place, the energy function equation obtains a weighted sum of the one or more first objective functions and the one or more second objective functions, and a weighting assigned to the one or more first objective functions is larger than a weighting assigned to the one or more second objective functions with such a degree that an operation plan for which the restriction conditions are not satisfied is not selected.

According to the aspects (1) to (10), it is possible to respond to a situation changing from moment to moment.

### BRIEF DESCRIPTION OF THE DRAWINGS

FIG. 1 is a diagram illustrating one example of an operation scene that is a processing target of an operation plan formulating device.

FIG. 2 is a configuration diagram of an operation plan formulating device 100.

FIG. 3 is a configuration diagram of a vehicle dispatch management device 50.

### DETAILED DESCRIPTION OF THE INVENTION

Hereinafter, an operation plan formulating device, a vehicle dispatch management device, an operation plan formulating method, and a storage medium according to an embodiment of the present invention will be described with reference to the drawings.

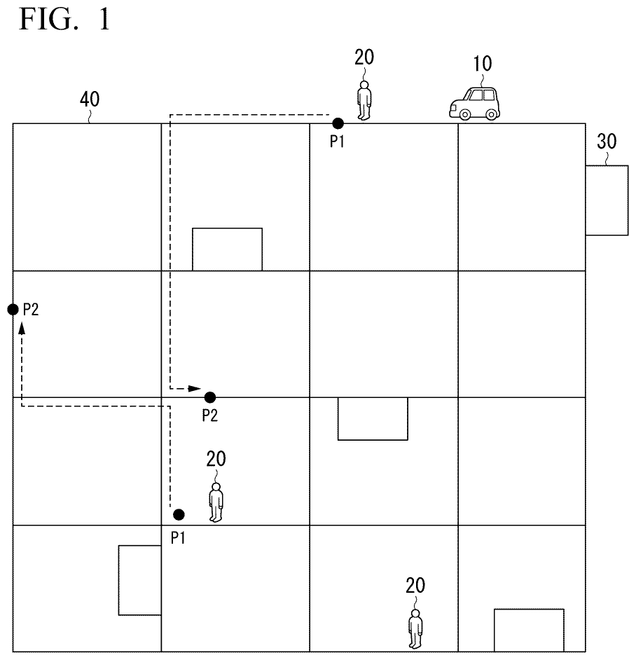

FIG. 1 is a diagram illustrating one example of an operation scene that is a processing target of an operation plan formulating device. In this operation scene, at an arbitrary place (a boarding location P1) in a certain specific closed region, a passenger 20 transmits a boarding request using a terminal device such as a smartphone or the like and will receive a transportation service. A vehicle 10 waits at a vehicle depot 30 when it is not being used for transportation, and when an instruction is received, the vehicle heads toward a boarding location P1, allows the passenger to board therein, and moves the passenger 20 to a drop-off location P2. Instead of this, the operation plan formulating device may have an operation scene in which the vehicle depot 30 is not set (for example, the vehicle 10 continuously moves like a taxi) as a processing target. In that case, the numerical equation may be appropriately corrected by omitting Target Events 3 and 4 to be described below, omitting a sum (Σ) of the left side of Restriction Condition 1, or the like. In the drawing, a road 40 is illustrated. A boarding request arrives at a vehicle dispatch management device (this may be the same device as an operation plan formulating device 100 to be described below or may be a device different from the operation plan formulating device 100) through a communication network, and a vehicle dispatch management device transmits a pickup instruction to the vehicle 10 in accordance with an operation plan formulated by the operation plan formulating device 100 or transmits a return instruction or the like to the vehicle depot 30, whereby a transportation service for passengers using the vehicle 10 is realized. The vehicle 10, for example, is a one-person boarding autonomous driving vehicle but is not limited thereto and may be a manned vehicle or may be a vehicle on which a plurality of persons can board. The operation scene may be a public transportation scene or may be a scene in which traffic participants are limited such as a golf course, an orchard, or a hospital. Hereinafter, in this region, it is assumed that a road structure, a distribution P(Sₖ) of boarding locations, a distribution P(O₁) of drop-off locations, and an appearance frequency of passengers 20 (a boarding request transmission frequency per hour) λ are known. A boarding location P1 and a boarding request transmission location may be the same or may be different from each other.

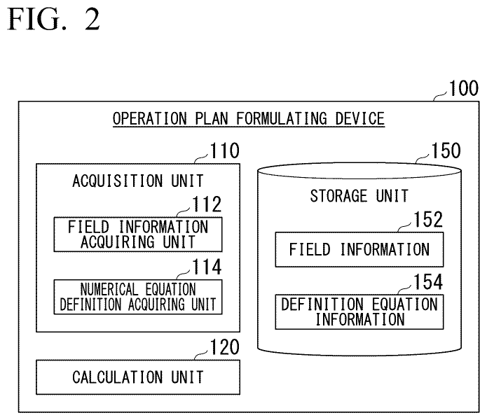

FIG. 2 is a configuration diagram of the operation plan formulating device 100. The operation plan formulating device 100, for example, includes an acquisition unit 110, a calculation unit 120, and a storage unit 150. The acquisition unit 110 includes a field information acquiring unit 112 and a numerical equation definition acquiring unit 114. Constituent elements other than the storage unit 150, for example, are realized by a hardware processor such as a central processing unit (CPU) executing a program (software). Some or all of such constituent elements may be realized by hardware (a circuit unit; including circuitry) such as a large scale integration (LSI), an application specific integrated circuit (ASIC), a field-programmable gate array (FPGA), a graphics processing unit (GPU), and a system on chip (SOC) or may be realized by software and hardware in cooperation. A program may be stored in advance in a storage device (a storage device including a non-transitory storage medium) such as a hard disk drive (HDD) or a flash memory or may be stored in a loadable/unloadable storage medium (a non-transitory storage medium) such as a DVD or a CD-ROM and be installed by loading the storage medium in a drive device. The storage unit 150 is a HDD, a flash memory, a random access memory (RAM), or the like and stores information such as field information 152 and definition equation information 154, and the like.

The field information acquiring unit 112 of the acquisition unit 110 acquires information such as a road structure, an average speed, a distribution P(Sₖ) of boarding locations, a distribution P(O₁) of drop-off locations, and an appearance frequency λ of passengers 20 that are stored in the storage unit 150 as field information 152.

The numerical equation definition acquiring unit 114 acquires an energy function equation defined as a sum of objective functions relating to an operation plan of a vehicle 10 by reading the definition equation information 154 of the storage unit 150. The objective functions may be set by an operator of a service or the like. In such a case, the operation plan formulating device 100, for example, acquires setting information of objective functions through an interface operating in an operator terminal device used by the operator of the service. The smaller (closer to zero) the value of an objective function, the more appropriate it is.

The calculation unit 120 calculates an operation plan minimizing the value of the energy function equation as an optimal solution. An operation plan defines, at least, which vehicle 10 is heading toward a certain boarding location P1, and which vehicle 10 is heading toward a certain vehicle depot 30 (in other words, destinations of vehicles 10) for a given boarding request with the number of vehicles 10 as a known number. The operation plan may further define an arrangement of one or more vehicle depots 30. In such a case, the vehicle depot 30 is not limited to being installed in accompaniment with construction according to an operation plan, and the operation plan may define which one among a plurality of vacant lots that are candidates for the vehicle depot 30 is used as the vehicle depot 30 in advance. Hereinafter, the operation plan is assumed to define both destinations of vehicles 10 and an arrangement of one or more vehicle depots 30. For example, all conceivable operation plans are comprehensively set, an energy function of each thereof is calculated, and then an operation plan that minimizes the energy function is calculated as an optimal solution.

Hereinafter, an objective function will be described. In the following description, reference signs 10, 20, and 30 will be appropriately omitted. The objective function includes one or more first objective functions based on whether or not restriction conditions are satisfied and one or more second objective functions for evaluating a degree of achievement of a target event. Although the restriction conditions, for example, include the following two conditions, they may include other restriction conditions.

### (Restriction Condition 1)

Restriction Condition 1 is “The number of destinations toward which one vehicle is heading is one.” When this restriction condition is represented as a first objective function, for example, it is a function H_{A0} represented in Equation (1). In the equation, i is an identifier of a vehicle, k is an identifier of a passenger, j is an identifier of a vehicle depot, σ_{vi,bj} is a function that becomes 1 in a case in which a vehicle i is heading toward a vehicle depot bⱼ and becomes zero otherwise, and σ_{vi,ck} is a function that becomes 1 in a case in which this vehicle i is heading toward a passenger cₖ and becomes zero otherwise. The function H_{A0} returns zero in a case in which the number of destinations toward which the vehicle i is heading is one and returns a value that is one or more otherwise.

$${H}_{{A}_{0}} = {\sum }_{i} {( 1 - {\sum }_{j} {σ}_{{v}_{i} , {b}_{j}} + {\sum }_{k} {σ}_{{v}_{i} , {c}_{k}} )}^{2} \qquad ( 1 )$$

### (Restriction Condition 2)

Restriction Condition 2 is “The number of vehicles heading toward one passenger is one.” When this restriction condition is represented as a first objective function, for example, it becomes a function H_{A1} represented in Equation (2).

$${H}_{{A}_{1}} = {\sum }_{k} {\sum }_{{i}_{1} < {i}_{2}} {σ}_{{v}_{{i}_{1}} , {c}_{k}} {σ}_{{v}_{{i}_{2}} , {c}_{k}} \qquad ( 2 )$$

Although target events, for example, include the following four events, they may include other events.

### (Target Event 1)

Target Event 1 is “A passenger whose waiting time has been long is prioritized, and going to pick up as many as passengers.” A second objective function corresponding to this target event, for example, is a function H_{B0} represented in Equation (3). In the equation, w_{ck} is a waiting time of a passenger, and wₘₐₓ is a maximum value of waiting times of all the passengers. w_{offset} is an offset value used for preventing a weighting of a passenger whose waiting time is zero from being zero. The waiting time, for example, is stored in the storage unit 150 as a part of the field information 152.

$${H}_{{B}_{0}} = {\sum }_{k} \{ \frac{{w}_{{c}_{k}} / {w}_{max} + {w}_{offset}}{1 + {w}_{offset}} {( 1 - {\sum }_{i} {σ}_{{v}_{i} , {c}_{k}} )}^{2} \} \qquad ( 3 )$$

### (Target Event 2)

Target Event 2 is “A total required time until arriving at a boarding location at the time of going to pick up a passenger is to be shortened.” A second objective function corresponding to this target event, for example, is function H_{B1} represented in Equation (4). In the equation, t_{vi,ck} is a required time until arrival at a boarding location at the time of a vehicle i going to pick up a passenger ck. The required time is calculated by the calculation unit 120 on the basis of information of a road structure and an average speed included in the field information 152 and a boarding location and a location of a vehicle.

$${H}_{{B}_{1}} = \frac{1}{{max}_{i , k} ( {t}_{{v}_{i} , {c}_{k}} )} {\sum }_{i , k} {t}_{{v}_{i} , {c}_{k}} {σ}_{{v}_{i} , {c}_{k}} \qquad ( 4 )$$

### (Target Event 3)

Target Event 3 is “Arranging of many vehicles at a vehicle depot present near a place at which an appearance frequency of a passenger is high.” A second objective function corresponding to this target event, for example, is a function H_{B2} represented in Equation (5).

$${H}_{{B}_{2}} = {\sum }_{j} {( {τ}_{{b}_{j}} - {\sum }_{i} {σ}_{{v}_{i} , {b}_{j}} )}^{2} \qquad ( 5 )$$

Here, τ_{bj} will be described. In the following description, Sₖ is an appearance place of a k-th passenger (more specifically, a transmission place of a boarding request), O₁ is an 1-th drop-off location, avg_pos is an average location of a vacant vehicle, and r is an average boarding rate. When defined in this way, an average vehicle dispatch time tbⱼ for each vehicle depot bⱼ is represented as in Equation (6). t_{bj,ride} is a time until a vehicle i on which a passenger is boarding arrives at a vehicle depot bⱼ, and t_{bj,not_ride} is a time until a vehicle i on which no passenger is boarding arrives at a vehicle depot bⱼ. A first term of t_{bj,ride} is a time until a vehicle i sends a boarding passenger to a drop-off location, and a second term is a time until the vehicle i arrives at a vehicle depot bⱼ after sending the passenger to the drop-off location. t_{bj,avg_pos} is a time until a vehicle is dispatched to a vehicle depot bⱼ from an average location of a vacant vehicle.

$${t}_{{b}_{j}} = {rt}_{{b}_{j} , ride} + ( 1 - r ) {t}_{{b}_{j} , not \_ ride} \qquad ( 6 )$$

$${t}_{{b}_{j} , ride} = \frac{1}{2} {\sum }_{k , l} P ( {s}_{k} ) P ( {o}_{l} ) {t}_{{s}_{k} , {o}_{l}} + {\sum }_{l} P ( {o}_{l} ) {t}_{{b}_{j} , {o}_{l}}$$

$${t}_{{b}_{j} , not \_ ride} = {t}_{{b}_{j} , avg \_ pos}$$

A probability p(x|Sₖ) of vehicle dispatch from a location x when a passenger appears at an appearance location Sₖ is acquired using Equation (7). t_{x,Sk} is a movement time from a location x to an appearance location Sₖ, t_{bj,Sk} is a movement time from a vehicle depot bⱼ to an appearance location Sₖ, t=t_{x,Sk} is an event that a vehicle dispatch time from a location x to an appearance location becomes t_{x,Sk}, v_{avg} is an average vehicle speed, and t_{avg} is an average waiting time (obtained by dividing a total waiting time of a passenger in an observation period up to the current time by the number of passengers within the observation period). A numerator of the rightmost term of Equation (7) assumes that a probability density of the vehicle dispatch time becoming tₓₖ follows an exponential function, and a denominator of the rightmost term represents that the longer the vehicle dispatch time, the father the location x and the appearance location Sₖ from each other, and the farther the place is, the probability density further decreases in proportion to a radius.

$$\begin{matrix}p ( x \vert {s}_{k} ) = p ( x , t = {t}_{x , {s}_{k}} \vert {s}_{k} ) \\ = p ( x \vert t = {t}_{x , {s}_{k}} , {s}_{k} ) p ( t = {t}_{x , {s}_{k}} \vert {s}_{k} ) ≅ \frac{{t}_{avg}}{2 π {t}_{x , {s}_{k}} {v}_{avg}} {e}^{- {t}_{avg} {t}_{x , {s}_{k}}}\end{matrix} \qquad ( 7 )$$

Then, by substituting the location x in Equation (7) with the vehicle depot bⱼ and substituting it into a center term of Equation (8), τ_{bj} is calculated using Equation (9).

$$P ( {b}_{j} \vert {s}_{k} ) ≅ \frac{p ( {b}_{j} \vert {s}_{k} )}{{\sum }_{j ′} p ( {b}_{j ′} \vert {s}_{k} )} = \frac{\frac{1}{{t}_{jk}} {e}^{- {t}_{avg} {t}_{{b}_{j} , {s}_{k}}}}{{\sum }_{j ′} \frac{1}{{t}_{{b}_{{j}^{′}} , {s}_{k}}} {e}^{-} {t}_{avg} {t}_{{b}_{{j}^{′}} , {s}_{k}}} \qquad ( 8 )$$

$${τ}_{{b}_{j}} = {t}_{{b}_{j}} λ {\sum }_{k} P ( {b}_{j} \vert {s}_{k} ) P ( {s}_{k} ) \qquad ( 9 )$$

### (Target Event 4)

Target Event 4 is “Shortening a total required time until arrival of a vehicle at a vehicle depot.” A second objective function corresponding to this target event, for example, is a function H_{B3} represented in Equation (10).

$${H}_{{B}_{3}} = {\sum }_{i , j} {t}_{{v}_{i} , {b}_{j}} {σ}_{{v}_{i} , {b}_{j}} \qquad ( 10 )$$

By using the first objective function and the second objective function described above as an example, the energy function is represented using Equation (11). The calculation unit 120, for example, calculates an energy function for each operation plan and selects an operation plan for which the energy function is a minimum as an optimal solution. Here, weightings α₀ and α₁ assigned to one or more first objective functions are larger than weightings β₀ to β₃ assigned to one or more second objective functions with a degree in which an operation plan for which a restriction condition is not satisfied is not selected. In other words, even in a case in which all the functions H_{B0}, H_{B1}, H_{B2}, and H_{B3} become possible minimum values, the weightings are set such that the energy function has not a minimum value unless one of the functions H_{A0} and H_{A1} is zero.

$$H = {α}_{0} {H}_{A 0} + {α}_{1} {H}_{A 1} + {β}_{0} {H}_{B 0} + {β}_{1} {H}_{B 1} + {β}_{2} {H}_{B 2} + {β}_{3} {H}_{B 3} \qquad ( 11 )$$

By performing as such, the process can be appropriately performed using an optimization device of an annealing type. As a result, an operation plan of vehicles operating with passengers allowed to ride therein can be appropriately (accurately and with a low load) generated. Since an operation plan is generated on the basis of past probabilistic information (a distribution P(Sₖ) of boarding locations, a distribution P(O₁) of drop-off locations, and an appearance frequency of passengers 20 (a boarding request transmission frequency per hour) λ), a situation changing from moment to moment can be appropriately responded.

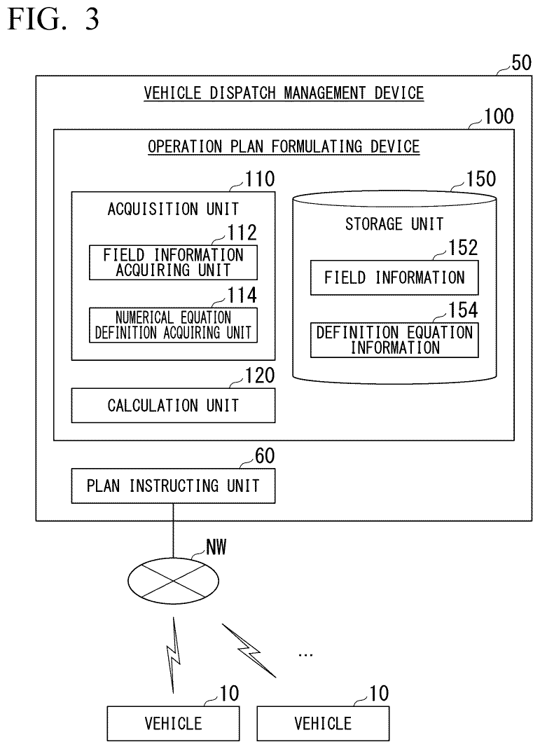

As described above, the operation plan formulating device may configure a vehicle dispatch management device together with a plan instructing unit transmitting an operation plan to a vehicle. FIG. 3 is a configuration diagram of a vehicle dispatch management device 50. The vehicle dispatch management device 50 includes an operation plan formulating device 100 and a plan instructing unit 60. The plan instructing unit 60, for example, is realized by a hardware processor such as a CPU executing a program (software) and may be realized by hardware such as an LSI, an ASIC, an FPGA, a GPU, or an SOC or may be realized by software and hardware in cooperation. The plan instructing unit 60 transmits an operation plan to at least the vehicle 10 through a network NW. The network NW is a wide area network (WAN), a local area network (LAN), the Internet, a Wi-fi network, a cellular network, or the like. When the arrangement of vehicle depots 30 is a content of “Which one of a plurality of vacant places will be used as a vehicle depot?”, the operation plan is achieved by transmitting the arrangement of vehicle depots 30 to the vehicle 10.

The embodiment described above can be expressed as below.

An operation plan formulating device formulating an operation plan of a plurality of vehicles in a service for a vehicle to transport a passenger from a boarding location to a drop-off location, the operation plan formulating device including a storage medium storing computer-readable instructions and a processor connected to the storage medium, the processor executing the computer-readable instructions to: acquire an energy function equation defined as a sum of objective functions relating to the operation plan of the vehicles; and calculate an operation plan minimizing an energy function as an optimal solution, in which the objective functions include one or more first objective functions based on whether or not restriction conditions are satisfied and one or more second objective functions for evaluating a degree of achievement of a target event, the restriction conditions include that a destination of the vehicle is one place, the energy function obtains a weighted sum of the one or more first objective functions and the one or more second objective functions, and a weighting assigned to the one or more first objective functions is larger than a weighting assigned to the one or more second objective functions with such a degree that an operation plan for which the restriction conditions are not satisfied is not selected.

As above, although a form for performing the present invention has been described using the embodiment, the present invention is not limited to such an embodiment at all, and various modifications and substitutions can be applied within a range not departing from the concept of the present invention.

What is claimed is:

1. An operation plan formulating device formulating an operation plan of a plurality of vehicles in a service for a vehicle to transport a passenger from a boarding location to a drop-off location, the operation plan formulating device comprising:
an acquisition unit configured to acquire an energy function equation defined as a sum of objective functions relating to the operation plan of the vehicles; and
a calculation unit configured to calculate an operation plan minimizing a value of the energy function equation as an optimal solution,
wherein the objective functions include one or more first objective functions based on whether or not restriction conditions are satisfied and one or more second objective functions for evaluating a degree of achievement of a target event,
wherein the restriction conditions include that a destination of the vehicle is one place,
wherein the energy function equation obtains a weighted sum of the one or more first objective functions and the one or more second objective functions, and
wherein a weighting assigned to the one or more first objective functions is larger than a weighting assigned to the one or more second objective functions with such a degree that an operation plan for which the restriction conditions are not satisfied is not selected.

2. The operation plan formulating device according to claim 1, wherein the operation plan defines which vehicle is heading toward a certain boarding location, and which vehicle is heading toward a certain vehicle depot for a given boarding request.

3. The operation plan formulating device according to claim 2, wherein the operation plan further defines an arrangement of one or more vehicle depots.

4. The operation plan formulating device according to claim 1, wherein the target event includes the passenger whose waiting time has been long being prioritized and going to pick up many passengers.

5. The operation plan formulating device according to claim 1, wherein the target event includes shortening of a total required time until arrival at the boarding location at the time of going to pick up a passenger.

6. The operation plan formulating device according to claim 3, wherein the target event includes placing many vehicles at a vehicle depot near a place at which an appearance frequency of the passenger is high.

7. The operation plan formulating device according to claim 2, wherein the target event includes shortening of a total required time until arrival of a vehicle at a vehicle depot.

8. A vehicle dispatch management device comprising:
the operation plan formulating device according to claim 1; and
a plan instructing unit configured to transmit the operation plan calculated by the calculation unit to at least a vehicle.

9. An operation plan formulating method executed using a computer and formulating an operation plan of a plurality of vehicles in a service for a vehicle to transport a passenger from a boarding location to a drop-off location, the operation plan formulating method comprising:
acquiring an energy function equation defined as a sum of objective functions relating to the operation plan of the vehicles; and
calculating an operation plan minimizing a value of the energy function equation as an optimal solution,
wherein the objective functions include one or more first objective functions based on whether or not restriction conditions are satisfied and one or more second objective functions for evaluating a degree of achievement of a target event,
wherein the restriction conditions include that a destination of the vehicle is one place,
wherein the energy function equation obtains a weighted sum of the one or more first objective functions and the one or more second objective functions, and
wherein a weighting assigned to the one or more first objective functions is larger than a weighting assigned to the one or more second objective functions with such a degree that an operation plan for which the restriction conditions are not satisfied is not selected.

10. A computer-readable non-transitory storage medium storing a program for formulating an operation plan of a plurality of vehicles in a service for a vehicle to transport a passenger from a boarding location to a drop-off location, the computer-readable non-transitory storage medium causing a computer to perform:
acquiring an energy function equation defined as a sum of objective functions relating to the operation plan of the vehicles; and
calculating an operation plan minimizing a value of the energy function equation as an optimal solution,
wherein the objective functions include one or more first objective functions based on whether or not restriction conditions are satisfied and one or more second objective functions for evaluating a degree of achievement of a target event,
wherein the restriction conditions include that a destination of the vehicle is one place,
wherein the energy function equation obtains a weighted sum of the one or more first objective functions and the one or more second objective functions, and
wherein a weighting assigned to the one or more first objective functions is larger than a weighting assigned to the one or more second objective functions with such a degree that an operation plan for which the restriction conditions are not satisfied is not selected.
